(19) United States
(12) Patent Application Publication
(10) Pub. No.: US 2022/0416638 A1
(43) Pub. Date: Dec. 29, 2022

(54) HELICAL MAGNET ARRANGEMENT FOR A MAGNETIC LINEAR ACTUATOR

(71) Applicant: National Oilwell Varco, L.P., Houston, TX (US)

(72) Inventors: Geoffrey Pickett, Sugar Land, TX (US); Craig Newman, Conroe, TX (US)

(21) Appl. No.: 17/776,319

(22) PCT Filed: Nov. 10, 2020
(86) PCT No.: PCT/US2020/059769

§ 371 Date: May 12, 2022

Related U.S. Application Data
(60) Provisional application No. 62/935,413, filed on Nov. 14, 2019.

(51) Int. Cl. H02K 41/03; H02K 1/27

(52) U.S. Cl. CPC H02K 41/031; H02K 1/27; H02K 49/102

(57) ABSTRACT

A magnetic linear actuator includes a stator and a rotor. The stator includes a first helical array of magnets. The rotor is disposed within the stator and includes a second helical array of magnets. The second helical array of magnets includes a first helical band of magnets and a second helical band of magnets. A first of the magnets of the first helical band coupled to at least one other of the magnets of the first helical band. A first of the magnets of the second helical band coupled to at least one other of the magnets of the second helical band.

### CROSS-REFERENCE TO RELATED APPLICATIONS

This application is a U.S. national phase application under 35 U.S.C. § 371 of international application No. PCT/US2020/059769 filed Nov. 10, 2020, entitled “Helical Magnetic Arrangement for a Magnetic Linear Actuator,” which claims priority to U.S. Provisional Patent Application No. 62/935,413, filed Nov. 14, 2019, entitled “Helical Magnet Arrangement for a Magnetic Linear Actuator,” all of which are hereby incorporated herein by reference in their entirety.

### BACKGROUND

A linear actuator is a device that creates straight line motion. Various techniques are employed to produce linear motion. Some linear actuators apply hydraulic pressure to move a piston. Other implementations of a linear actuator convert rotary motion into linear motion. For example, a threaded shaft, or a nut or roller screw assembly coupled to the threaded shaft, may be rotated to longitudinally extend or retract the shaft. An electric motor may provide the rotation needed to translate the shaft.

### SUMMARY

Magnetic linear actuators and magnet arrangements for use in a magnetic linear actuator are disclosed herein. In one example, a magnetic linear actuator includes a stator and a rotor. The stator includes a first helical array of magnets. The rotor is disposed within the stator and includes a second helical array of magnets. The second helical array of magnets includes a first helical band of magnets and a second helical band of magnets. Each of the magnets of the first helical band in contact with at least one other of the magnets of the first helical band. Each of the magnets of the second helical band in contact with at least one other of the magnets of the second helical band.

In another example, a magnetic linear actuator includes a stator and a rotor. The stator includes a first helical array of magnets. The first helical array of magnets includes a first helical band of magnets, a second helical band of magnets, a third helical band of magnets, and a fourth helical band of magnets. At least some of the magnets of the first helical band of magnets, at least some of the magnets of the second helical band of magnets, at least some magnets of the third helical band of magnets, and at least some magnets fourth helical band of magnets comprise a rhomboidal (shaped like a rhombus or a rhomboid) top profile. The rotor is disposed within the stator and includes a second helical array of magnets.

In a further example, a magnetic linear actuator includes a stator and a rotor. The stator includes a first helical array of magnets. The first helical array of magnets includes a first helical band of magnets, a second helical band of magnets, a third helical band of magnets, and a fourth helical band of magnets. At least some of the magnets of the first helical band of magnets, at least some of the magnets of the second helical band of magnets, at least some magnets of the third helical band of magnets, and at least some magnets fourth helical band of magnets comprise a rectangular top profile. The rotor is disposed within the stator and includes a second helical array of magnets.

### BRIEF DESCRIPTION OF THE DRAWINGS

For a detailed description of various examples, reference will now be made to the accompanying drawings in which:

FIG. 1 shows a partially sectional view of a magnetic linear actuator in a retracted position in accordance with the present disclosure;

FIG. 2 shows a partially sectional view of a magnetic linear actuator in an extended position in accordance with the present disclosure;

FIG. 3 shows an example magnet array in which the magnets are arranged in a north-south orientation;

FIG. 4 shows an example magnet array in which the magnets are arranged as a Halbach array;

FIGS. 5A and 5B show examples of magnets arranged as a helical Halbach array on a stator and rotor of a magnetic linear actuator in accordance with the present disclosure;

FIGS. 6A and 6B show examples of magnets having a rectangular top profile arranged in helical bands in accordance with the present disclosure; and

FIGS. 7A and 7B show examples of magnets having a rhomboidal top profile arranged in helical bands in accordance with the present disclosure.

### DETAILED DESCRIPTION

The following discussion is directed to various exemplary embodiments. However, one of ordinary skill in the art will understand that the examples disclosed herein have broad application, and that the discussion of any embodiment is meant only to be exemplary of that embodiment, and not intended to suggest that the scope of the disclosure, including the claims, is limited to that embodiment. The exemplary embodiments presented herein, or any elements thereof, may be combined in a variety of ways, i.e., any element from one exemplary embodiment may be used in any other exemplary embodiment, without departing from the scope of the disclosure.

The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a given axis (e.g., central axis of a body or a port), while the terms “radial” and “radially” generally mean perpendicular to the given axis. For instance, an axial distance refers to a distance measured along or parallel to the axis, and a radial distance means a distance measured perpendicular to the axis. The term “rhomboidal” means shaped like a rhombus or a rhomboid.

Linear actuators that convert rotary motion generated by an electric motor to linear motion are subject to a number of limitations. For example, the linear force produced by such actuators is generally lower than the force provided by a hydraulic device, friction between the various components of such actuators limits the life of the actuator, and the cost may be relatively high.

Magnetic linear actuators reduce or eliminate friction between parts by using interaction of magnetic fields to convert rotary motion to linear motion. The magnetic linear actuators disclosed herein include a rotor and stator, each of which includes a helical array of magnets producing a magnetic field. Rotation of one of the rotor or stator induces linear motion of one or the other of the rotor or stator by interaction of the magnetic fields. For example, rotation of the rotor may induce linear motion of the rotor or the stator to maintain alignment of the magnetic fields. To improve the flux density between rotor and stator, magnets of the rotor and stator may be arranged as Halbach array. Each helical band of magnets disposed on the rotor or stator may be formed using magnets having a square top profile or a rhomboidal top profile. The rhomboidal top profile may provide substantially higher flux density between the stator and rotor than the rectangular top profile. In some implementations, a helical band may include magnets having a trapezoidal top profile and provide advantages similar to those of the rhomboidal top profile.

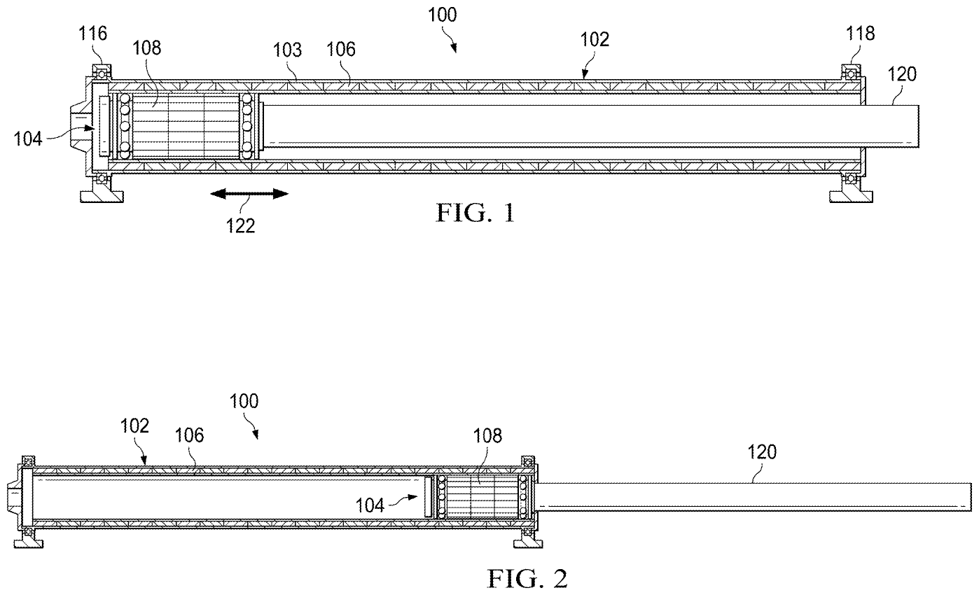

FIG. 1 shows a partially sectional view of a magnetic linear actuator 100 in a retracted position in accordance with the present disclosure. The magnetic linear actuator 100 includes a stator 102, and a rotor 104. The stator 102 includes an outer shell 103, and magnets 106 arranged in a helical array within the outer shell 103. The outer shell 103 may be generally cylindrical in shape. Some implementations of the stator 102 include a bearing 116 and a bearing 118. The stator 102 rotates on the bearing 116 and the bearing 118. In such implementations, the stator 102 may be referred to as a rotating stator, and the rotor 104 may be referred to a stationary rotor.

The rotor 104 is disposed within the bore of the stator 102. The bore and the rotor 104 may be generally cylindrical in shape. The rotor 104 includes magnets 108 arranged in a helical array disposed on the outer circumference of the rotor 104. A shaft 120 extends from the rotor 104 in some implementations of the magnetic linear actuator 100. Interaction of the magnetic fields produced by the magnets 106 and the magnets 108 cause the rotor 104 to move longitudinally (in the direction 122) responsive to rotation of the stator 102. In FIG. 1, the rotor 104 is disposed at a first end of the stator 102 (i.e., the rotor 104 is retracted), and in FIG. 2, the rotor 104 is disposed at a second end of the stator 102 (i.e., the rotor 104 is extended). For example, rotation of the stator 102 in a first direction may cause the rotor 104 to move longitudinally within the stator 102 from the first end of the stator 102 to the second end of the stator 102, and rotation of the stator 102 in a second direction (opposite the first direction) may cause the rotor 104 to move longitudinally within the stator 102 from the second end of the stator 102 to the first end of the stator 102.

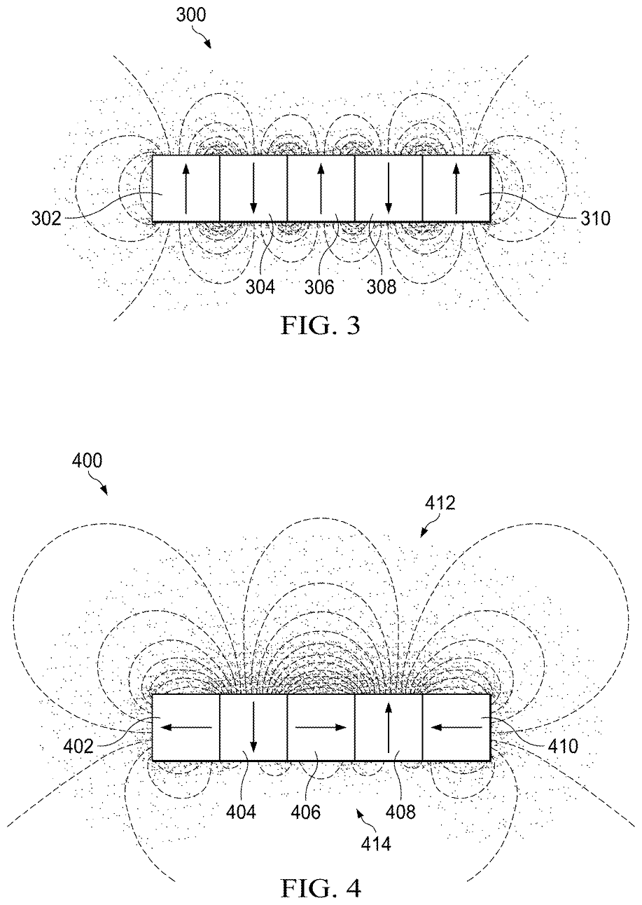

In some implementations of the stator 102 and the rotor 104, the magnets 106 and the magnets 108 are arranged as Halbach arrays. FIG. 3 shows an example magnet array 300 in which the magnets 302-310 are arranged in a north-south orientation. The magnets 302, 306, and 310 are oriented in one direction, and the magnets 304 and 308 are oriented in the opposite direction. In a Halbach array, the magnets are not arranged in a north-south orientation or alternating polarity as in the magnet array 300. Rather, in a Halbach array, the magnets are arranged in a north-east-south-west orientation that pushes the flux of the array in one direction. Because flux density and linkage are important to increasing performance in electric rotating machines, the Halbach array is very advantageous.

FIG. 4 shows an example Halbach array 400. The Halbach array 400 includes magnets 402-410, where each successive magnet is rotated about 90° counterclockwise with respect to the previous magnet (e.g., magnet 404 is rotated about 90° counterclockwise with respect to magnet 402, magnet 406 is rotated about 90° counterclockwise with respect to magnet 404, etc.). Some implementations of the Halbach array 400 rotate each successive magnet about 80°-100° with respect to the previous magnet. This arrangement increases the magnet flux on side 412 of the of the Halbach array 400 and decreases the magnetic flux on the side 414 of the Halbach array 400. In an implementation of the stator 102, a side of the magnets 106 nearest the rotor 104 corresponds to the side 412 of the Halbach array 400, and in an implementation of the rotor 104, the side of the magnets 108 nearest the stator 102 corresponds to the side 412 of the Halbach array 400.

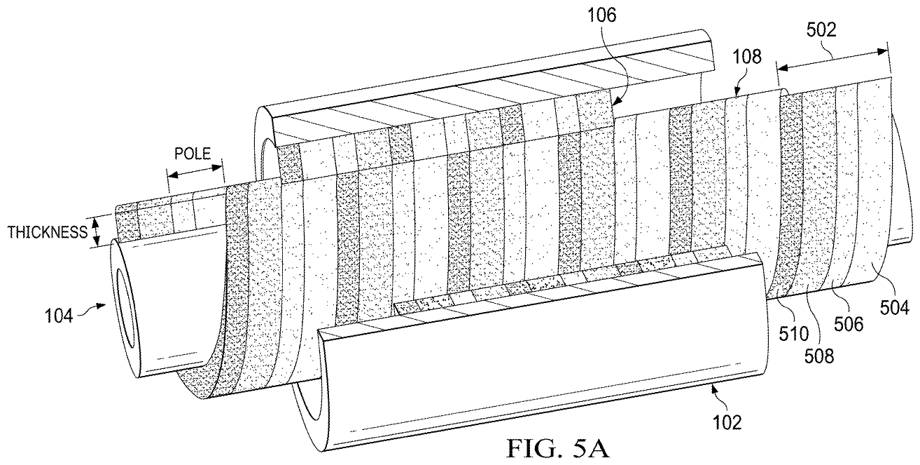

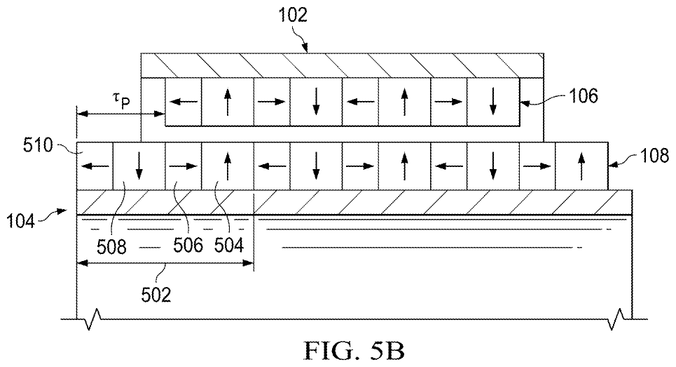

FIGS. 5A and 5B show a portion of the stator 102 with magnets 106 arranged as a helical Halbach array, and a portion of the rotor 104 with magnets 108 arranged as a helical Halbach array. A set of four helical bands 502 forms a Halbach array, where each band includes magnets oriented in one of the four orientations that make up the Halbach array. For example, helical band 504 includes only magnets with north orientation, helical band 506 includes only magnets with east orientation, helical band 508 includes only magnets with south orientation, and helical band 510 includes only magnets with west orientation. FIG. 5B shows alignment of the magnets 106 and the magnets 108. As the 102 rotates, the 104 is displaced to maintain the illustrated alignment of the magnets 106 and the magnets 108.

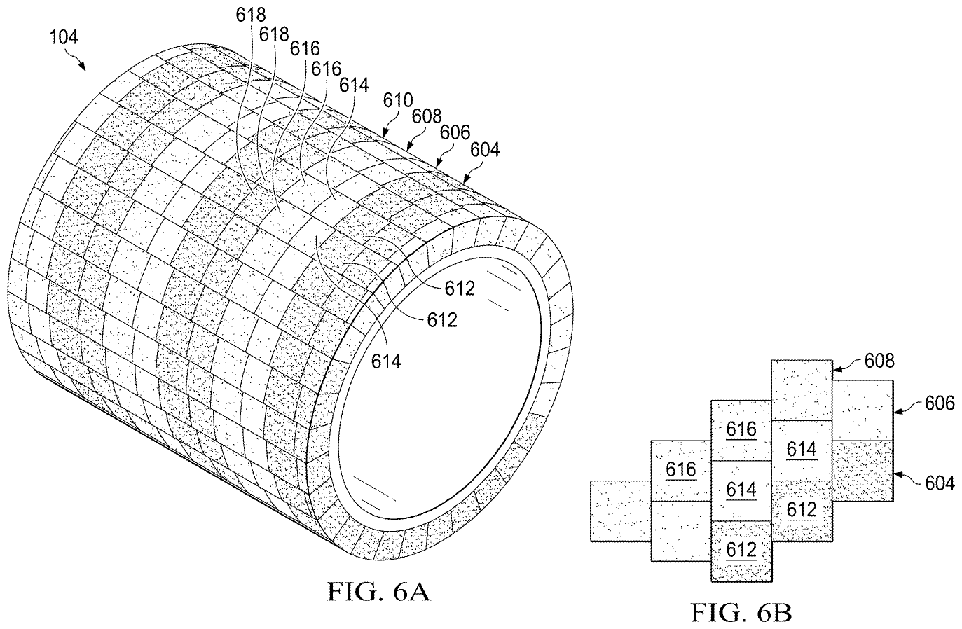

FIGS. 6A and 6B show examples of magnets having a rectangular top profile arranged in helical bands in accordance with the present disclosure. In FIG. 6A, the rotor 104 includes a helical array of magnets arranged as four helical bands: helical band 604, helical band 606, helical band 608, and helical band 610. Each of the helical bands may include magnets arranged in a single orientation to form a Halbach array as shown in FIG. 5B. For example, the magnets 612 of the band 604 may be arranged in north orientation, magnets 614 of the band 606 may be arranged in east orientation, magnets 616 of the band 608 may be arranged in south orientation, and magnets 618 of the band 610 may be arranged in west orientation.

In the implementation of the rotor 104 shown in FIG. 6A, the top profile of the magnets is rectangular, and, in each band, a helix is formed by offsetting each successive magnet in the direction of the axis of the rotor 104 (i.e., longitudinally) with respect to the previous magnet of the band. FIG. 6B shows the stairstep pattern formed by offsetting each successive magnet of a band along the axis of the rotor 104 to form a helical band. The magnets may be formed such the outer surface is arcuate to provide a relatively smooth cylindrical outer surface for the rotor 104. In various implementations of the rotor 104, a magnet of a given helical band may be in contact with or coupled to via flux linkage a different magnet of the given helical band, and/or a magnet of a different helical band.

The stator 102 may include bands of magnets having a rectangular top profile arranged in stairstep fashion to form helixes. The magnets may be formed such that the outer surface is arcuate to provide a relatively smooth cylindrical inner surface for the stator 102.

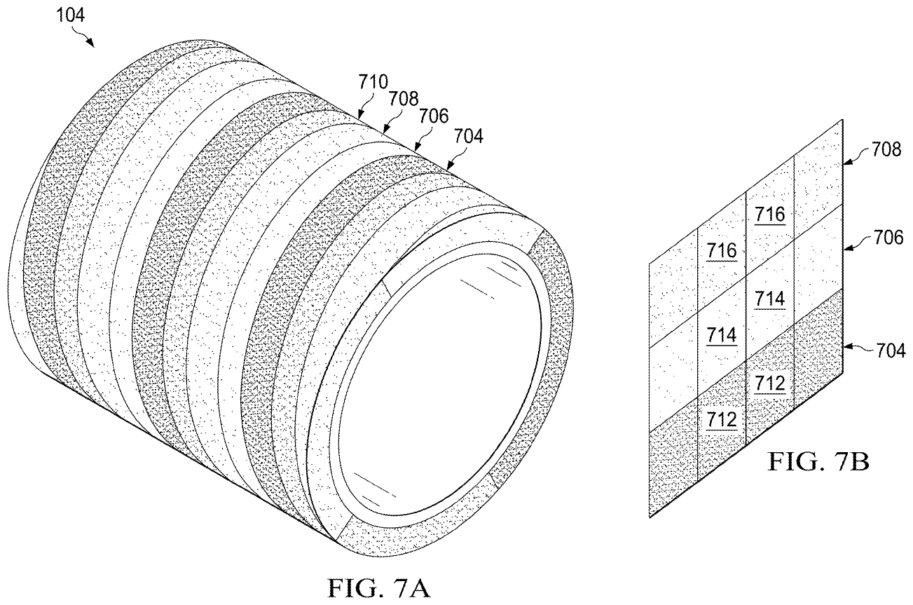

In the stairstep (non-contiguous) geometry of FIGS. 6A and 6B, the flux lines emanating from the magnets are curved in an undesirable way, and the flux density in the air gap between the stator 102 and the rotor 104 is reduced. FIGS. 7A and 7B show examples of magnets having a rhomboidal top profile arranged in helical bands in accordance with the present disclosure. While the rectangular magnets of FIGS. 6A and 6B may be cheaper and easier to install, the rhomboidal magnet profile of FIGS. 7A and 7B greatly reduces the losses and can increase flux density between the stator 102 and the rotor 104 by as much as 20% in some implementations.

In FIG. 7A the rotor 104 includes a helical array of magnets arranged as four helical bands: helical band 704, helical band 706, helical band 708, and helical band 710. Each of the bands may include magnets arranged in a single orientation to form a Halbach array as shown in FIG. 5B. For example, the magnets 712 of the band 704 may be arranged in north orientation, magnets 714 of the band 706 may be arranged in east orientation, magnets 716 of the band 708 may be arranged in south orientation, and magnets 718 of the band 710 may be arranged in west orientation.

In the implementation of the rotor 104 shown in FIG. 7A, the top profile of the magnets is rhomboidal, and, in each band, a helix is formed by aligning each successive magnet with the previous magnet of the band. FIG. 7B shows the pattern formed by aligning each successive magnet of a band with the preceding magnet to form a helical band. The magnets may be formed such the outer surface is arcuate to provide a relatively smooth cylindrical outer surface for the rotor 104. In various implementations of the rotor 104, the magnets of a given helical band may be in contact with or coupled to via flux linkage a different magnet of the given helical band, and/or a magnet of a different helical band.

The stator 102 may include bands of magnets having a rhomboidal top profile arranged to form helixes. The magnets may be formed such that the outer surface is arcuate to provide a relatively smooth cylindrical inner surface for the stator 102.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other items shown or discussed as coupled may be directly coupled or may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A magnetic linear actuator, comprising:
a stator comprising a first helical array of magnets; and
a rotor disposed within the stator, and comprising a second helical array of magnets;
wherein:
the second helical array of magnets comprises a first helical band of magnets, a first of the magnets of the first helical band is coupled to a second of the magnets of the first helical band; and
the second helical array of magnets comprises a second helical band of magnets, and a first of the magnets of the second helical band is coupled to a second of the magnets of the second helical band.

2. The magnetic linear actuator of claim 1, wherein the first of the magnets of the first helical band is coupled to at least one of the magnets of the second helical band.

3. The magnetic linear actuator of claim 1, wherein:
the magnets of the first helical band comprise a rectangular top profile; and
the magnets of the second helical band comprise a rectangular top profile.

4. The magnetic linear actuator of claim 1, wherein at least some of the magnets of the first helical band, and at least some of the magnets of the second helical band comprise a rhomboidal top profile.

5. The magnetic linear actuator of claim 1, wherein the rotor comprises a cylindrical shaft, wherein each of the magnets of the first helical band, and each of the magnets of the second helical band is arcuate to match an outer surface of the cylindrical shaft.

6. The magnetic linear actuator of claim 1, wherein:
the second helical array of magnets comprises a third helical band of the magnets, and a first of the magnets of the third helical band is coupled to at least one other of the magnets of the third helical band;
the second helical array of magnets comprises a fourth helical band of the magnets, and a first of the magnets of the fourth helical band is coupled to at least one other of the magnets of the fourth helical band; and
the magnets of the first helical band, the second helical band, the third helical band, and the fourth helical band are arranged to form a Halbach array.

7. The magnetic linear actuator of claim 1, wherein:
the first helical array of magnets comprises:
a fifth helical band of magnets;
a sixth helical band of the magnets disposed in parallel with the fifth helical band of magnets;
a seventh helical band of the magnets disposed in parallel with the sixth helical band of magnets; and
an eighth helical band of the magnets disposed in parallel with the seventh helical band of magnets;
wherein the magnets of the fifth helical band, the sixth helical band, the seventh helical band, and the eighth helical band are arranged to form a Halbach array.

8. The magnetic linear actuator of claim 1, wherein:
at least some of the magnets of the fifth helical band comprise a rectangular top profile or a rhomboidal top profile;
at least some of the magnets of the sixth helical band comprise a rectangular top profile or a rhomboidal top profile;
at least some of the magnets of the seventh helical band comprise a rectangular top profile or a rhomboidal top profile; and
at least some of the magnets of the eighth helical band comprise a rectangular top profile or a rhomboidal top profile.

9. A magnetic linear actuator, comprising:
a stator comprising a first helical array of magnets; wherein:
the first helical array of magnets comprises:
a first helical band of magnets;
a second helical band of magnets;
a third helical band of magnets; and
a fourth helical band of magnets;
wherein at least some of the magnets of the first helical band of magnets, at least some of the magnets of the second helical band of magnets, at least some magnets of the third helical band of magnets, and at least some magnets fourth helical band of magnets comprise a rhomboidal top profile; and
a rotor disposed within the stator, and comprising a second helical array of magnets.

10. The magnetic linear actuator of claim 9, wherein the second helical array of magnets comprises:
a fifth helical band of magnets;
a sixth helical band of magnets;
a seventh helical band of magnets; and
an eighth helical band of magnets;
wherein at least some of the magnets of the fifth helical band of magnets, at least some of the magnets of the sixth helical band of magnets, at least some magnets of the seventh helical band of magnets, and at least some magnets eighth helical band of magnets comprise a rhomboidal top profile.

11. The magnetic linear actuator of claim 10, wherein the fifth helical band of magnets, the sixth helical band of magnets, the seventh helical band of magnets, and the eighth helical band of magnets are arranged to form a Halbach array.

12. The magnetic linear actuator of claim 10, wherein:
a first of the magnets of the fifth helical band is coupled to a second of the magnets of the fifth helical band;
a first of the magnets of the sixth helical band is coupled to a second of the magnets of the sixth helical band;
a first of the magnets of the seventh helical band is coupled to a second of the magnets of the seventh helical band; and
a first of the magnets of the eighth helical band is coupled to a second of the magnets of the eighth helical band.

13. The magnetic linear actuator of claim 9, wherein the first helical band of magnets, the second helical band of magnets, the third helical band of magnets, and the fourth helical band of magnets are arranged to form a Halbach array.

14. The magnetic linear actuator of claim 9, wherein:
a first of the magnets of the first helical band is coupled to a second of the magnets of the first helical band;
a first of the magnets of the second helical band is coupled to a second of the magnets of the second helical band;
a first of the magnets of the third helical band is coupled to a second of the magnets of the third helical band; and
a first of the magnets of the fourth helical band is coupled to a second of the magnets of the fourth helical band.

15. A magnetic linear actuator, comprising:
a stator comprising a first helical array of magnets; wherein the first helical array of magnets comprises:
a first helical band of magnets;
a second helical band of magnets;
a third helical band of magnets; and
a fourth helical band of magnets;
wherein at least some of the magnets of the first helical band of magnets, at least some of the magnets of the second helical band of magnets, at least some magnets of the third helical band of magnets, and at least some magnets fourth helical band of magnets comprise a rectangular top profile; and
a rotor disposed within the stator, and comprising a second helical array of magnets.

16. The magnetic linear actuator of claim 15, wherein the second helical array of magnets comprises:
a fifth helical band of magnets;
a sixth helical band of magnets;
a seventh helical band of magnets; and
an eighth helical band of magnets;
wherein at least some of the magnets of the fifth helical band of magnets, at least some of the magnets of the sixth helical band of magnets, at least some magnets of the seventh helical band of magnets, and at least some magnets eighth helical band of magnets comprise a rectangular top profile.

17. The magnetic linear actuator of claim 16, wherein the fifth helical band of magnets, the sixth helical band of magnets, the seventh helical band of magnets, and the eighth helical band of magnets are arranged to form a Halbach array.

18. The magnetic linear actuator of claim 16, wherein:
a first of the magnets of the fifth helical band is coupled to a second of the magnets of the fifth helical band;
a first of the magnets of the sixth helical band is coupled to a second of the magnets of the sixth helical band;
a first of the magnets of the seventh helical band is coupled to a second of the magnets of the seventh helical band; and
a first of the magnets of the eighth helical band is coupled to a second of the magnets of the eighth helical band.

19. The magnetic linear actuator of claim 15, wherein the first helical band of magnets, the second helical band of magnets, the third helical band of magnets, and the fourth helical band of magnets are arranged to form a Halbach array.

20. The magnetic linear actuator of claim 15, wherein:
a first of the magnets of the first helical band is coupled to a second of the magnets of the first helical band;
a first of the magnets of the second helical band is coupled to a second of the magnets of the second helical band;
a first of the magnets of the third helical band is coupled to a second of the magnets of the third helical band; and
a first of the magnets of the fourth helical band is coupled to a second of the magnets of the fourth helical band.
